(19) United States
(12) Patent Application Publication
(10) Pub. No.: US 2004/0139159 A1
(43) Pub. Date: Jul. 15, 2004

(54) System and method for multiplayer mobile games using device surrogates

(76) Inventors: Aleta Ricciardi, West Windsor, NJ (US); William Swaney, Princeton Junction, NJ (US)

Correspondence Address: STUART RUDOLER LLC, 2 BALA PLAZA, SUTIE 300, BALA CYNWYD, PA, 19004, US

(21) Appl. No.: 10/645,407

(22) Filed: Aug. 21, 2003

Related U.S. Application Data
(60) Provisional application No. 60/405,488, filed on Aug. 23, 2002.

(51) Int. Cl. G06F 15/16

(52) U.S. Cl. 709/205; 463/42

(57) ABSTRACT

A system and method allows multiple remote devices to form ad hoc groups over a network to participate in an activity. Each remote device is represented by a software surrogate, that is usually specific to the activity, device and communication channel. Where the remote device has limited computational power its surrogate can handle much of the computation necessary to participate in the activity. The surrogate can also queue communication to and from a remote device to make up for communication lapses common in wireless networks. The surrogate can also track usage information and persist the state of the activity. One embodiment is for multi-player gaming over cellular data networks using telephones, PDAs or the like. Another embodiment is for communication between emergency first responders.

### CROSS REFERENCE TO RELATED APPLICATION

The present application claims the benefit of U.S. Provisional Application No. 60/405,488, filed Aug. 23, 2002, the entire disclosure of which is incorporated herein by reference.

### BACKGROUND OF INVENTION

Recent trends have seen a tremendous increase in the popularity of multiplayer games being played over networks, including the Internet. While some such games are relatively simple, such as checkers or chess, other games are relatively complicated, such as hunt and shoot games or racing games. The advantages to online gaming are that end users can form ad hoc communities who are interested in games of a particular type and/or skill level. Multiplayer games require sophisticated algorithms to update the players as to the state of the game and moves made by other players, as well as to implement the rules of the game and determine the results of players' moves. In addition, the software must allow players to create and enter into games as well as to exit from games. Multiplayer games are, by their nature, distributed collaborative applications and therefore lend themselves to a distributed computing infrastructure for their execution and management. Traditionally, multiplayer games have been played on personal computers or specialized gaming devices (such as Nintendo®, Sega® or X-Box™) connected to each other via a network, including the Internet. Since each player has access to dedicated computational resources (i.e., the PC or gamebox) many of the computing tasks can be distributed among the various computing devices.

A distributed computing system is a collection of autonomous computing entities, hardware or software, connected by some communication medium. While often the computing entities are geographically dispersed, in some instances they might be separate processors in a multi-processor computer or even separate software routines executing in logically isolated memory space on the same computer. A computing entity need not be a traditional computer, but more generally can be any computing device, ranging from a large mainframe to a refrigerator or a cell phone. A distributed application is an application that executes on a distributed system and one in which parts of the application execute on distinct autonomous computing entities.

Mobile telephone carriers have now begun to offer online games to their subscribers. As mobile handsets have become more and more sophisticated with better graphic displays, these games have become more sophisticated as well. Today's mobile telephones and other mobile computing devices, such as personal digital assistants (PDAs) and communicators (combination cell phone/PDA), allow end users to communicate both voice and data over the telephone network and, in some cases, via the Internet.

Mobility delivers a unique experience for game players providing on-the-move convenience while at the same time allowing players to join into group play without care for co-location, power plugs or Internet access lines. In extending the multi-player game experience to a global level, mobility will create a usage phenomenon that will radically expand upon the current number of game players. Yet delivering an excellent playing experience requires an additional set of capabilities to overcome the idiosyncrasies of wireless networks and the limitations of mobile devices.

Coordinating group activities among remote participants over any communications network is notoriously difficult due to the uncertainties that arise from unpredictable network latency, unpredictable network connectivity, unpredictable end point reliability, and an unpredictable desire for participants to join and leave. This uncertainty, which is exacerbated in mobile networks, makes it impossible to reach important decisions related to the game experience. To make this concrete, in a multi-player game framework, the game could not be guaranteed to start correctly; if it started correctly it could not be guaranteed to play out correctly; and if it played out correctly, it couldn't be guaranteed to terminate correctly. In the constrained environment of mobile networks and handsets, even the intricate work-arounds that researchers have devised over the past 15 years become impractical. They do not scale in group size, numbers of groups, and the cost of supporting intra-group communication. A radically different approach is required to ensure exceptional user experiences for mobile multi-player games and other mobile collaborative applications.

When people gather to play a game, such as Poker, Bridge or Monopoly®, they have already achieved a level of communal knowledge that is naturally missing in the be-anywhere, mobile world. A group of players that are co-present achieve common knowledge of basic things: the existence and number of other players (perfect membership information), the fact that a move was made, the relative order in which each move was made, and what the move was (all thanks to perfect communication and observation). This further allows them as a group to derive with certainty, a unique ranking of members and the global state of the game (board configuration, cards played, whose turn it is).

While communication is the only way to increase knowledge, it is costly in network use and can adversely affect the user experience because it adds to game delays. Researchers in distributed computing have devised and honed sophisticated communication algorithms to increase knowledge and achieve related forms of consensus; some algorithms have message complexity that scales linearly with the number of participants, while others scale quadratically. For example, to reach agreement among n players, a linear algorithm would (in the best case) exchange 2(n−1) messages; a quadratic algorithm would exchange (n−1)(n−1). While obviously less costly with the communication medium, linear algorithms have several drawbacks: they have more points of failure, involve more complex failure recovery, and take longer to complete (they are more serial than parallel).

Even the most basic consensus (all members agreeing on either a 0 or a 1, and no members reaching different decisions) is impossible to achieve all the time in systems that have the same unreliability characteristics as the mobile environment. Either the algorithm must admit some executions in which no decision will be reached or some executions in which two members decide differently. Most of the time, well-thought-out algorithms do reach consensus, but no algorithm can be assured of doing so all the time. The situations that cause these aberrations are characterized by longer than usual communication latency, poorer than usual network quality of service, and higher than usual processor demand.

Hundreds of millions of mobile devices use J2ME, a restricted subset of the Java™ programming language (of which J2SE is the standard), for resident and down-loadable applications. RMI (remote method invocation) and Jini Network Technology™ extend J2SE so that Java applications that exist independently throughout a network can interact. While the ability to interact with other devices is crucial for enabling collaborative applications among mobile devices, today's constrained devices and constrained networks do not support these IP-based protocols (the inability to interact applies to non-Java technologies, such as Qualcomm's BREW™ platform and the Symbian operating system).

Within the Jini and Java communities, the Surrogate Project was implemented to facilitate interactivity between the J2ME device to full Java and RMI-capable applications. Surrogates are code modules that act on behalf of J2ME devices within the network. They perform processing for the J2ME device and handle communications between the J2ME device and the rest of the network.

### BRIEF DESCRIPTION OF THE INVENTION

The present invention comprises a system and method that allows multiple remote devices to form ad hoc groups over a network to participate in an activity. Each remote device is represented by a software surrogate that is usually specific to the activity, device and communication channel. Where the remote device has limited computational power, its surrogate can handle much of the computation necessary to participate in the activity. The surrogate can also queue communication to and from a remote device to make up for communication lapses common in wireless networks. The surrogate can also track usage information and persist the state of the activity. One embodiment of the invention is for multi-player gaming over cellular data networks using telephones, PDAs or the like. Another embodiment of the invention is for communication between emergency first responders.

### BRIEF DESCRIPTION OF THE DRAWINGS

FIG. 1 is a block diagram of the invention showing multiple remote devices and multiple surrogates.

FIG. 2 is a flow chart showing the process of a player making a mover and each of the remote devices updating the state of the game, where each of the surrogates calculates the game state.

FIG. 3 is a flow chart showing the process of a player making a mover and each of the remote devices updating the state of the game, where only one of the surrogates calculates the game state.

### DETAILED DESCRIPTION OF THE INVENTION

The present invention uses software surrogates, executing in a capable environment, to represent end user hardware devices within that environment. In addition to simply passing data back and forth to the handset, as in the Surrogate Project, the present invention exploits the surrogate-style architecture to facilitate mobile collaborative applications, to greatly enhance the end user experience within the collaborative application, and to increase the value that content developers and wireless carriers obtain from mobile collaborative applications. In particular, in the present invention the surrogate 1) is the locus of the logic that relates specifically to group collaboration; 2) mitigates the computational limits of the handset; 3) mitigates the unreliability of mobile communication; and 4) captures usage information about the collaborative application.

With respect to group collaboration, the surrogate interacts with a group service to receive membership changes, inform the group service of the unreachability or failure of the device and application it is representing, gracefully exit the collaborative application on behalf of an unresponsive device, participate in group communication and transactional algorithms, and use and manage shared group assets, such as tokens.

With respect to mitigating computational limits, the surrogate can, for example, perform computations such as 3D rendering, access control, and authentication that are not feasible or possible on the limited device, and it can persist the state of the application on capable servers. This is especially important with respect to the present generation of cell phones and PDAs which have limited computational capabilities. While these devices may be capable of relatively simple games, games with advanced logic or even more than the most rudimentary graphics are beyond their computational capacity. Through the use of the surrogates, the computational activities can be divided between the remote device and the hardware platform on which the surrogate is running.

With respect to mitigating communication, the surrogate can store information destined for its device when that device is unreachable, send that information upon re-establishing contact with the device, and coordinate with other surrogates that reside on the same computing platform as itself to prioritize and shape traffic. The ability of a surrogate to compensate for communications lapses is of particular benefit with respect to mobile remote devices because of the noisiness and lapses inherent in today's wireless data transfer networks.

With respect to usage information capture, the surrogate can monitor and report on traffic sent over the wireless network (useful for both billing purposes and network operations), capture the use of other carrier resources pertaining to the application, capture the repeated usage of the application (useful for marketing purposes, and developer reimbursement), capture the outcome of a game, capture and record disconnect and latency data, and so forth.

U.S. patent application Ser. No. 09/928,028, filed Aug. 10, 2001 and U.S. patent application Ser. No. 09/940,367, filed on Aug. 28, 2001, the entire disclosures of which are both incorporated herein by reference, disclose a system and methodology for forming and operating groups in a distributed computing environment using mobile code. In solving the problems inherent in multi-player game playing over distributed networks, it is useful to treat the surrogates of the devices that are playing in each game instance as a group. There may be multiple simultaneous groups playing the same game, for example, forty-five simultaneous chess game groups, or ten simultaneous poker table groups. The techniques disclosed in the two patents referenced above may be applied to implement the grouping of surrogates.

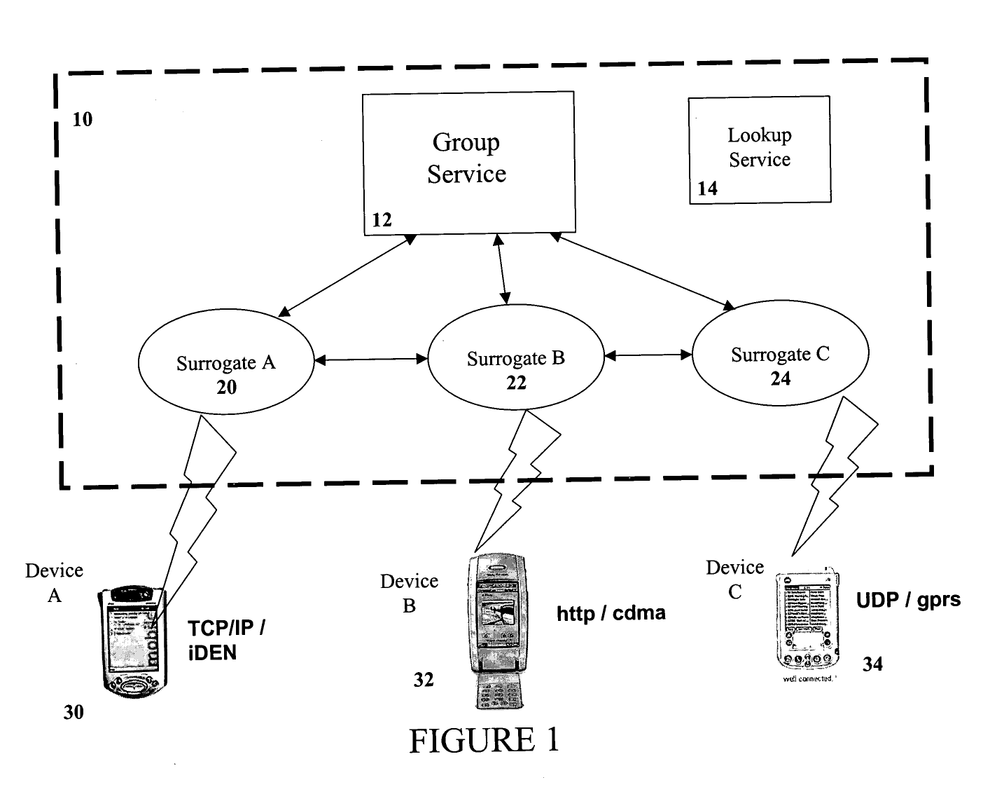

FIG. 1 shows the generic implementation of the invention. Devices A 30, B 32 and C 34 are three different mobile communication devices, each using its own operating system, hardware and communication format. In the example Device A 30 is Microsoft® Windows® PDA operating over a wireless TCP/IP IDEN network, Device B 32 is a telephone operating over a http-based wireless CDMA network, and Device C 34 is a PDA running Palm® OS and operating over a wireless UDP/GPRS network. Each device has a separate communication path and protocol, a different operating system, different display size and resolution, and is based on a different microprocessor.

While not shown, not all of the remote devices are necessarily of limited computational capability. For example, a person with a laptop PC and a wireless internet connection may wish to play a game with a friend on a mobile telephone. Indeed, not all of the devices need to be wireless, some may be connected through a traditional network. For example, a graduate student at a university working on a Unix based workstation may want to participate in a multiplayer game with others on wireless PDAs. As long as an appropriate surrogate is available for the device and communication network, any type of device can join the environment. In certain circumstances, where there are reliable communication and capable hardware, the computational tasks normally performed by the surrogate may be performed by the remote device itself, thus relieving the network environment of computational burden and making use of spare computational power on the remote device. The elegance of the surrogate solution described herein, is that since the surrogates are device and communication network specific, the system designer can customize each surrogate to take advantage of the inherent capabilities of each. In one embodiment of the invention, the surrogate may even offload computational tasks to its remote device dynamically depending on the network load.

When the game application on any of the remote devices 30, 32, 34 is initiated, it contacts a known address to request that an appropriate surrogate 20, 22, 24 be instantiated for it. Applications running on handsets are called a MIDlet in the J2ME setting and that term will be used generically, even when the handset-resident application is not written in Java, and the application may be running on non-handset type devices.

Since the surrogate may contain activity specific or game-specific logic, as well as device specific logic, in most instances the surrogate is specific to the remote device that it services and the particular game that is being played. While it is possible for a surrogate to service multiple device types and/or play multiple games, it is desirable in terms of code efficiency (i.e. size) and debugging, to have dedicated surrogates for each device type and game.

The surrogate is a software module that may be instantiated on demand, and acts on behalf of the remote gaming device. The surrogate executes in a capable network computing environment 10. From the point of view of the rest of the network and collaborative application, the surrogate is the participant in the mobile collaborative application. Preferably, the surrogate includes or is provided with a grouping agent by a group service 12 also executing within the network environment, although the logic to interact with a group may be incorporated within the surrogate. The grouping agent (not shown) is a piece of mobile code assigned to a surrogate that handles the group activities with respect to the group service and other surrogates.

The tasks of handling the particular communication protocol and hardware/software idiosyncrasies of each device are handled by the surrogate for that device. From the point of view of the mobile collaborative application, all the participants are the same. In essence, the combined functionality packaged by the surrogate plus device plus MIDlet is identical across all platforms; what differs in each setting is the exact breakdown of which functionality is executed in each component.

The task of locating the resources for and instantiating an instance of a particular service (in this case a surrogate) within a distributed computing environment are well known within the art of distributed computing, and particularly among Jini/Java programmers. Likewise creation of computational containers on hardware resources to execute particular resources is well known to those skilled in the field.

In the preferred embodiment, the activity logic, the “game, is partitioned among the MIDlet and the surrogate. In the chess example, the handset may have enough computing power to ascertain whether a given move is legal, but not enough to determine whether the opponent is now in check. That computation is done by the surrogate.

In still another embodiment, a game service may be made available to provide additional or special features to players. In the chess example, a player might pay extra to be able to have an expert chess server recommend a move. Such a game service, or more generically an activity service, is accessed by the surrogates to provide the desired functionality.

In yet another embodiment, the game logic is contained wholly within each of the surrogates. For example, in a game of chess, each surrogate may keep track of the state of the entire board, and as they receive information from the other surrogates about various players' moves, each of the surrogates calculates the new state of the board. In the chess example, if Player1 moves its knight to take Player2's pawn, both Surrogate1 and Surrogatge2 calculate the logic to remove the pawn from the board. Absent perfect and reliable communication in this environment, the surrogates check each other's state to detect and correct discrepancies. This type of configuration lends itself to a peer grouping of surrogates.

While having the surrogates each calculate the application or game state has certain advantages, in certain applications, particularly real time games like racing cars or hunt and shoot games, this may be impractical or impossible. For such applications there may be a game service that controls the state and calculates the state of the game. For instance, in a race car game the game service may calculate the map, acceleration and direction of each of the vehicles and return the track and car state to each of the surrogates. The game service need not be a separate service, but may actually be one of the surrogates. In one such embodiment, the surrogates are in a coordinator cohort arrangement and the surrogate whose player currently has the turn acts as the coordinator, calculating the state of the game and distributing the state to the other players.

As noted above, the implementation of the application game logic need not be handled exclusively by the surrogates or exclusively by a game service. Tasks can be divided with some logic being handled centrally by a game service (which may be one of the surrogates in the group) and some of the logic being handled by the surrogates. In the racing car example, each surrogate may calculate its own direction and velocity. The game service can calculate each of the surrogates' (i.e. cars') position on the track, relative positions and events of collisions with obstacles or other cars. The game service then provides this information back to each of the surrogates. It will be obvious that there are many ways the computational tasks can be divided among a central game service and the surrogates. As discussed above, computational tasks can also be offloaded to a remote device, depending on its capabilities.

Continuing in FIG. 1, the capable network environment 10 is a distributed computing environment consisting of one or more physical and logical computing devices that can all communicate with one another through a network. Typically, this will be a distributed computing environment with a number of computer servers running various applications. In the preferred embodiment the network environment 10 can execute mobile code, and provide a lookup service 14 for various resources, services and clients to register and find each other. The particular hardware, network and software environment is not critical to the invention, although the invention is presently implemented in Java/Jini. In the case of remote gaming, the network environment 10 may be controlled and internal to the wireless phone/data service provider that is offering the gaming services, or it may be hosted externally by an application service provider. For convenience, the network environment 10 is shown inside the dashed box, and the remote devices 30, 32, 34 are shown outside the box. This is a logical, and not a physical distinction, and many parts of the network environment 10 may be physically remote from each other. In the preferred embodiment, the network environment 10 can instantiate surrogates 20, 22, 24 at the request of the remote devices 30, 32, 34 and provide computational containers in which those surrogates execute.

A capable network environment is minimally one in which the computing entities are the usual home or office computers: laptop, desktop and even server computers. Also, the communication network should be at least the equivalent 10 Mbit Ethernet, whether wired with coaxial cable or wireless over 802.11×although any protocol and medium may used. The salient features are that memory and bandwidth are plentiful, I/O is simple, and communication within the environment is reliable.

Upon requesting to use a particular application/game, each device is provided with a surrogate 20, 22, 24 particular to that device. Each surrogate 20, 22, 24 can communicate with its remote device 30, 32, 34. Although the present invention focuses on the cellular wireless networks, the surrogate is still of significant value in a wired network.

Devices A 30, B 32 and C 34 have all decided to play the same game, and their respective surrogates 20, 22, 24 have found each other and formed a group. The task of finding other players with which to form a group can be handled in a variety of ways. The surrogates can query one another and/or they can register with a game lookup service 14. Players, through their surrogates 20, 22, 24, can be grouped arbitrarily, by skill level, by invitation, or any other groupings desired. Players can look for each other by username. In certain types of games, such as those where players move from room to room or planet to planet (more generally scene to scene) a game may have hundreds of players with those in the same scene arranged into a common group. Groups may be static, that is not allowing new players until a game is finished, or dynamic, with surrogates joining and exiting groups during the course of the game.

In the preferred embodiment, although not necessary to the invention, a group service 12 is deployed within the network environment 10 to assist the surrogates 20, 22, 24 in the grouping functions. As described in patent application Ser. Nos. 09/928,028 and 09/940,367 referenced above, the group service can assist each of the surrogates (each of which is a service) in performing the group functions. It can also assist the group as it is represented to the rest of the distributed environment resembling a single application. In one embodiment, the group service provides each surrogate a group proxy for the group in which the surrogate is participating. The proxy contains all of the grouping logic and in some embodiments can be switched dynamically to achieve various types of group dynamics. Alternatively, the group logic may be embedded into each surrogate.

As shown, a lookup service 14 may be available to assist the surrogates in finding various other services and resources that they need. This may be game specific services, such as maps and graphic files, or generic services, such as clocks, security services, persistent storage, calculators, or GPS locators.

While in FIG. 1, the three surrogates 20, 22, 24 form a single group, and the network environment 10 will preferably have many groups running simultaneously as it hosts many simultaneous games.

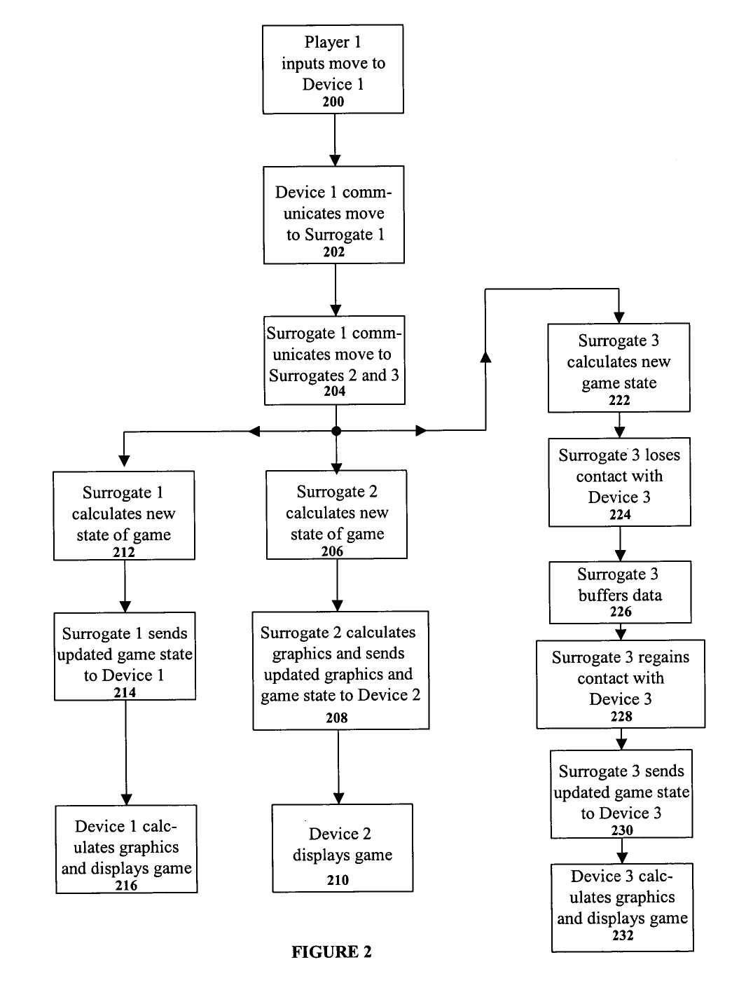

FIG. 2 shows a flow chart of a typical process with a group of three players. Player 1 takes a move and inputs his move into Device 1 200. Device 1 then communicates the move to its surrogate, Surrogate 1 202. Surrogate 1 then communicates the move to Surrogates 2 and 3 204. Each of Surrogates 1, 2 and 3 apply their logic to calculate the new state of the game 212, 206, 222. Now the various surrogates take different paths. Device 1 has a relatively simple system and/or the capability of calculating its own graphics display. Therefore, Surrogate 1 does not need to calculate complex graphics and sends the updated game state to Device 1 214. Device 1 then calculates the appropriate graphics and displays the game to Player 1 216. On the other hand, Device 2 has a very sophisticated screen but does not have sufficient computational power to render the game in 3D graphics. Therefore, in addition to Surrogate 2 calculating the state of the game 206, it also calculates the graphics and sends the updated graphics and game state to Device 2 208. Then Device 2 displays the game 210. Device 3 is having an intermittent communication problem with the network and Surrogate 3 loses contact with Device 3 224. Surrogate 3 therefore buffers the data 226 until it regains contact with Device 3 228 at which time Surrogate 3 sends the updated game state to Device 3 230, and Device 3 calculates the graphics and displays the game 232.

It should be noted that in FIG. 2, the surrogates may be organized in a peer group with each surrogate calculating the state of the game in parallel with the other two surrogates. Assuming perfect communication and identical game logic in each of the surrogates, they should reach an identical state. However, it may be necessary for them to have a routine to reach consensus when their states are not the same. One simple method of resolving differences in the state of the game is a majority rules routine where two of the surrogates can out-vote the third. Such routines are well known in the art of parallel computing and distributed computing and will now be explained in further detail here.

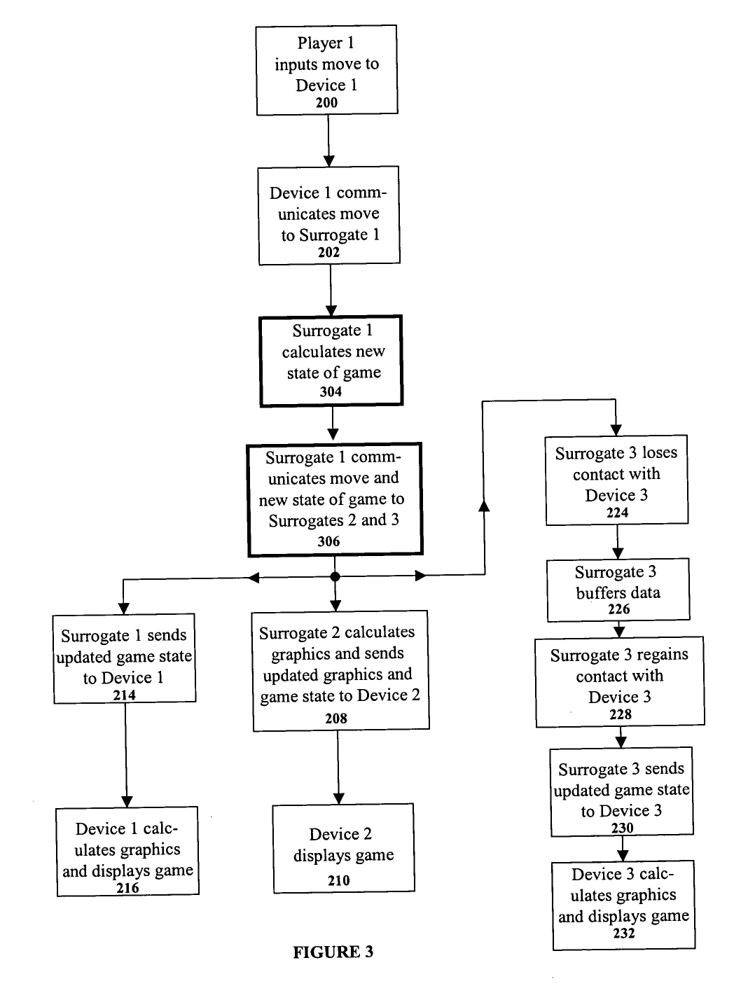

FIG. 3 is similar to FIG. 2, except in this case, only one of the surrogates calculates the state of the game 304 and then communicates the move of Player 1, as well as the new state of the game to Surrogates 2 and 3 306. In FIG. 3, the steps that have changed from FIG. 2 are outlined in bold (Steps 304 and 306). Also note that steps 212 and 222 of FIG. 2 are not necessary in FIG. 3. This type of arrangement may be implemented through a coordinator cohort group.

A game of Chinese checkers will now be used to demonstrate the various capabilities of the surrogate.

Consider a game of Chinese checkers between players on remote devices A1, . . . , A5 over mobile networks N1, . . . , N5 using protocols P1, . . . , P5. The surrogates S1, . . . , S5, for A1, . . . A5, have already been instantiated (as above) on capable computers. On her remote device, player A1 moves a marble (for simplicity, remote devices and their players are treated here as common elements); the MIDlet on A1 communicates the move using communication protocol P1 over network N1 to S1. S1 invokes its grouping agent to distribute the move to S2, . . . , S5, which communicate the move to A2, . . . A5, using P2 over N2, . . . P5 over N5. The MIDlets on the other handsets update the display to reflect A1's move. It is now A2's turn.

It is also instructive to describe examples of surrogates' group behavior. In passing the move to the other surrogates, S1 also passes a “turn token” to S2, allowing only A2 to make a move. S1 invokes its group agent's reliable, ordered multicast to distributed A1's move to the other surrogates. Also, before the game begins, the surrogates run a consensus algorithm to agree to start the game and not wait for a sixth player. A4 is unreachable for an extended period when it is her turn; S4 passes the token to S5 and invokes the leave-group method on the grouping service.

As previously discussed, the use of surrogates is helpful in mitigating communication problems. During the attempt to relay A1's move to A2, S2 is unable to communicate with the handset; S2 holds the information about A1's move in a local buffer and continues to try to contact the handset; when contact is re-established, the move is sent.

Many tasks can be performed by the surrogates during playing of the game. After receiving A1's move, S1 persists the state of the game from A1's perspective to non-volatile storage (for example by writing to a log service or hard drive). After successfully transmitting the state of the game to A2, . . . A5, S2, . . . , S5 may likewise persist the state of the game. Surrogates can more reliably persist the state of the game than remote devices since they have access to non-volatile storage within the network environment.

Another task that surrogates may perform is rule enforcement. Suppose A5 attempts to move when it is not his turn (for example, S5 does not have the move token). S5 can send a message to the A5 device saying “Not your turn,” along with instructions to graphically undo the move. Note that the other surrogates and the other remote devices were not burdened by A5's mistake. Another possible surrogate task is complex graphics rendering. Suppose A2's remote device has a brilliant color display, then S2 computes and transmits to it a 3-dimensional rendering of the game board to enhance A2's game playing experience. On the hand, A3's remote device my be rudimentary, and S3 sends a text based graphic.

Surrogates are also useful for information capture, particularly for billing purposes. Surrogates can count the bytes received from and sent to their respective handsets. They can also keep a timer for the duration of game play. S2, reflecting the nature of N2 and P2, keeps a counter of the number of unsuccessful attempts to contact its handset. All surrogates may record the winner. In a collaborative presence application, in evolving strategy games, and when passively observing a collaborative activity (for example, watching a chess game) members frequently depart and rejoin the application; in these applications membership changes do not critically alter the application. However, the member who has left and expects to rejoin the application requires its local application state to be persisted. Moreover, the surrogate instantiated when the member returns must be able to find and transmit that state. Thus, prior to leaving the game the surrogate can store its state with a log service or other network resource, and later retrieve that information when it is reactivated.

Surrogates are also capable of handling players exiting a game while it is being played. This may happen either because of a communication lapse of longer than a certain length of time, or because a player simply turns off his or her phone. In this scenario, instead of just losing communication with the device, from the view of the game service and the surrogates, the surrogates for the discontinued device are still there. It may indicate loss of communication with a device and request to exit the game, so that such an exit can be handled in a nonfatal matter with respect to the remaining players. In a game of checkers where the loss of a single player will end the game, this may simply result in a message being sent to the other player. Alternatively, the game service may inform the remaining player that the first player has left the game and request if it would like an automated player to finish the game. In games that have a large number of players, such as search and destroy games, the exiting of a player may have no impact on the continuing of the game.

Surrogates and groups can even be used in single player modes where a player is playing against the computer. In this case, the “opponent” can be instantiated as its own surrogate which includes the necessary logic to act as player.

It should be noted that surrogates are capable of acting from anywhere with respect to the distributed application. They can execute on the same computing platform as the group service (if there is one), the game service (if there is one), or any other available computing resources. Preferably, surrogates execute on an independent set of computers from the telecom infrastructure computers, so that they can be managed to provide the best handset-to-network performance. Also, in the example of gaming over a telephone network, the system designer would not want the communication and billing infrastructure to be directly burdened with the task of running games. All surrogates in a group need not execute on a single hardware platform, and, in fact, different hardware platforms may be desirable to match the surrogate to the wireless network that it is working over to reach its remote device. On the other hand, surrogates in the same group might be executed on a single hardware server to eliminate communication latencies and overhead.

While the invention as described herein is applicable to gaming, the use of surrogates and ad hoc groups as described herein may be applied to other applications, such as emergency first responders. Generically, such applications are referred to herein as an activity. Moreover, the surrogate can also perform security and authentication functions on behalf of the handset, which are not crucial in the gaming area. In this setting, the groups are different incidents such as a building fire, an automobile accident, an earthquake, or an escaped prisoner, and the group members are the responders from the relevant agencies (e.g., fire, police, EMT, FBI). First, the surrogate joins the responder to the appropriate incident. After that, the collaborative application for a given incident can exhibit the same variability as within multi-player game types. For example, the collaborative application for an incident might be something as simple as presenting the profiles and expertise of each responder, so that everyone knows who is on the site and how to contact them; it might be more complex and allow responders to update a shared map and they assess damage to a site. In fact, there is little technical difference between players updating a shared Monopoly board and responders updating a shared blueprint of a building after an earthquake wreaks enormous damage to it. Similarly, the invention can be applied to military maneuvers or financial trading, and the invention is meant to cover all such applications of the use of groups of surrogates to coordinate activities between ad hoc groups.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

We claim:

1. A distributed computing system comprising:
a capable network environment;
a plurality of remote computing devices in communication with the capable network environment; and
a plurality of surrogates operating within the capable network environment;
wherein each of the remote computing devices is associated with one of the surrogates and the surrogates are logically organized into groups allowing the remote devices related to the grouped surrogates to participate in an activity together.

2. The distributed computing system of claim 1 wherein at least one of the surrogates is comprised of:
a software module for communicating with the remote computing device with which it is associated;
a software module for communication with the other surrogates;
a software module for calculating changes of state with respect to the activity;
a software module for calculating the state of the activity;
a software module for storing its state with respect to the activity;
a software module for capturing usage, activity and outcome; and
a software module for buffering data and later transmitting communication to its computing device;
wherein each of the surrogates represents its associated remote computing device within the distributed computing application.

3. The distributed computing system of claim 2 wherein the at least one of the surrogates is further comprised of a group proxy.

4. The distributed computing system of claim 1 further comprising a group service operating within the network environment.

5. The distributed computing system of claim 1 wherein the activity is a multi-player game and each remote computing device is a game input/output device for a game player.

6. The distributed computing system of claim 1 wherein the activity is an emergency first responder support system.

7. The distributed computing system of claim 1 wherein the remote computing devices are cellular telephones, personal digital assistants, communicators, dedicated game devices, personal computers, laptop computers or work stations.

8. The distributed computing system of claim 1 wherein the remote computing devices are connected to the capable network environment via a wireless network, telephone network, wide area network, local area network or the Internet.

9. The distributed computing system of claim 1 wherein the capable network environment is comprised of a plurality of computers interconnected via a high speed network.

10. The distributed computing system of claim 9 wherein the computers are personal computers, work stations or network servers.

11. A method of operating a multi-user activity comprising the steps of:
a first remote device contacting a capable network environment and requesting to participate in the activity;
the network environment instantiating a first surrogate assigned to the first remote device;
a second remote device contacting the capable network environment and requesting to participate in the activity;
the network environment instantiating a second surrogate assigned to the second remote device;
arranging the first surrogate and the second surrogate into a group; and
the first remote device and the second remote device participating in the activity together.

12. The method of claim 11 further comprising the step of the first surrogate and the second surrogate registering with a group service.

13. The method of claim 12 further comprising the step of the group service providing the first surrogate with a first group proxy and the second surrogate with a second group proxy.

14. The method of claim 11 wherein the group is a coordinator cohort group or a peer group.

15. The method of claim 11 wherein the activity is a multi-player game and each remote computing device is a game input/output device for a game player.

16. The method of claim 11 wherein the activity is an emergency first responder support system.

17. The method of claim 11 wherein the remote computing devices are cellular telephones, personal digital assistants, communicators, dedicated game devices, personal computers, laptop computer or work stations.

18. The method of claim 11 wherein the remote computing devices are connected to the capable network environment via a wireless network, telephone network, wide area network, local area network or the Internet.

19. The method of claim 11 wherein the capable network environment is comprised of a plurality of computers interconnected via a high speed network.

20. The method of claim 19 wherein the computers are personal computers, work stations or network servers.

21. A computer readable medium containing instruction for controlling a computer system to perform a method of operating a multi-user activity comprising the steps of:
a first remote device contacting a capable network environment and requesting to participate in the activity;
the network environment instantiating a first surrogate assigned to the first remote device;
a second remote device contacting the capable network environment and requesting to participate in the activity;
the network environment instantiating a second surrogate assigned to the second remote device;
arranging the first surrogate and the second surrogate into a group; and
the first remote device and the second remote device participating in the activity together.

22. The computer readable medium of claim 21 wherein the method is further comprised of the step of the first surrogate and the second surrogate registering with a group service.

23. The computer readable medium of claim 21 wherein the method is further comprised of the step of the group service providing the first surrogate with a first group proxy and the second surrogate with a second group proxy.

24. The computer readable medium of claim 21 wherein the group is a coordinator cohort group or a peer group.

25. The computer readable medium of claim 21 wherein the activity is a multi-player game and each remote computing device is a game input/output device for a game player.

26. The computer readable medium of claim 21 wherein the activity is an emergency first responder support system.

27. The computer readable medium of claim 21 wherein the remote computing devices are cellular telephones, personal digital assistants, communicators, dedicated game devices, personal computers, laptop computer or work stations.

28. The computer readable medium of claim 21 wherein the remote computing devices are connected to the capable network environment via a wireless network, telephone network, wide area network, local area network or the Internet.

29. The computer readable medium of claim 21 wherein the capable network environment is comprised of a plurality of computers interconnected via a high speed network.

30. The computer readable medium of claim 29 wherein the computers are personal computers, work stations or network servers.

31. A multiplayer gaming system for wireless telephone networks comprising:
a wireless telephone network;
a capable network environment connected to the telephone network;
a plurality of mobile devices wirelessly connected to the telephone network; and
a plurality of surrogates operating within the capable network environment;
wherein each of the remote computing devices is associated with one of the surrogates and the surrogates are logically organized into groups allowing the remote devices related to the grouped surrogate to participate in an activity together.

32. The gaming system of claim 31 further comprising a plurality of group proxies associated with the surrogates.

33. The gaming system of claim 31 further comprising a group service operating within the network environment.

34. The gaming system of claim 31 wherein the mobile devices are cellular telephones, personal digital assistants, communicators, dedicated game devices, or laptop computers.

35. The gaming system of claim 31 wherein the mobile devices are connected to the capable network environment via a wireless network, telephone network, wide area network, local area network or the Internet.

36. The gaming system of claim 31 wherein the capable network environment is comprised of a plurality of computers interconnected via a high speed network.

37. The gaming system of claim 36 wherein the computers are personal computers, work stations or network servers.

38. The gaming system of claim 31 wherein at least one of the surrogates in the group calculates the state of the activity.

39. The gaming system of claim 31 wherein at least one of the mobile devices includes a software MIDlet that performs a portion of the game functions.

40. A method of operating a multi-user game comprising the steps of:
a first mobile device contacting a capable network environment and requesting to participate in the game;
the network environment instantiating a first surrogate assigned to the first mobile device;
a second mobile device contacting the capable network environment and requesting to participate in the activity;
the network environment instantiating a second surrogate assigned to the second mobile device;
arranging the first surrogate and the second surrogate into a group; and
the first mobile device and the second mobile device participating in the game together.

41. The method of claim 40 further comprising the step of the first surrogate and the second surrogate registering with a group service.

42. The method of claim 41 further comprising the step of the group service providing the first surrogate with a first group proxy and the second surrogate with a second group proxy.

43. The method of claim 40 wherein the group is a coordinator cohort group or a peer group.

44. The method of claim 40 wherein the mobile devices are cellular telephones, personal digital assistants, communicators, dedicated game devices or laptop computers.

45. The method of claim 40 wherein the capable network environment is comprised of a plurality of computers interconnected via a high speed network.

46. A computer readable medium containing instruction for controlling a computer system to perform a method of operating a multi-user game comprising the steps of:
a first mobile device contacting a capable network environment and requesting to participate in the game;
the network environment instantiating a first surrogate assigned to the first mobile device;
a second mobile device contacting the capable network environment and requesting to participate in the activity;
the network environment instantiating a second surrogate assigned to the second mobile device;
arranging the first surrogate and the second surrogate into a group; and
the first mobile device and the second mobile device participating in the game together.

47. The computer readable medium of claim 46 wherein the method is further comprised of the step of the first surrogate and the second surrogate registering with a group service.

48. The computer readable medium of claim 46 wherein the method is further comprised of the step of the group service providing the first surrogate with a first group proxy and the second surrogate with a second group proxy.

49. The computer readable medium of claim 46 wherein the group is a coordinator cohort group or a peer group.

50. The computer readable medium of claim 46 wherein the mobile devices are cellular telephones, personal digital assistants, communicators, dedicated game devices or laptop computers.

51. The computer readable medium of claim 46 wherein the capable network environment is comprised of a plurality of computers interconnected via a high speed network.

52. The computer readable medium of claim 51 wherein the computers are personal computers, work stations or network servers.
